(19) United States
(12) Patent Application Publication
(10) Pub. No.: US 2003/0051992 A1
(43) Pub. Date: Mar. 20, 2003

(54) Synthetic combustible gas generation apparatus and method

(75) Inventors: Phillip M. Rappa, New Port Richey, FL (US); Richard A. Lyons, St. Petersburg, FL (US); Ruggero M. Santilli, Palm Harbor, FL (US)

Correspondence Address: WINSTON & STRAWN, PATENT DEPARTMENT, 1400 L STREET, N.W., WASHINGTON, DC, 20005-3502, US

(73) Assignee: EarthFirst Technologies, Inc.

(21) Appl. No.: 10/073,601

(22) Filed: Feb. 11, 2002

Related U.S. Application Data
(63) Continuation of application No. PCT/US00/13465, filed on May 16, 2000.

(51) Int. Cl. H05F 3/00; B01J 19/08; B01J 19/12

(52) U.S. Cl. 204/164; 422/186.04

(57) ABSTRACT

A method of obtaining a supply of a synthetic combustible gas having enhanced combustion properties by providing a fluid containing a carbonaceous material, creating an electric arc between spaced electrodes under the fluid to generate a combustible gas, and collecting the gas to obtain the supply of the combustible gas. An apparatus for obtaining a supply of a combustible gas having enhanced combustion properties includes a fluid containing a carbonaceous material, a vessel for retaining the fluid, spaced electrodes positioned in the vessel below the fluid, means for creating an electric arc between the spaced electrodes to generate a combustible gas, and means for collecting the gas for obtaining the supply of the gas.

### CROSS-REFERENCE TO RELATED APPLICATIONS

This application is a continuation of PCT Application No. PCT/US00/13465, filed May 16, 2000, now pending, which claims the benefit of Application No. 09/372,278, filed Aug. 11, 1999, the contents of each of which are incorporated herein by express reference thereto.

### FIELD OF INVENTION

The invention relates to a method of obtaining a supply of a synthetic combustible gas by flowing a fluid through an arc between spaced electrodes. The invention also relates to an apparatus for obtaining a supply of the synthetic combustible gas.

### BACKGROUND OF THE INVENTION

Processes to produce a combustible gas from underwater arcs between carbon electrodes have been known in the art. The arc is generally produced between two carbon rods immersed in water via a DC power unit, such as a welder absorbing 15 KW of real electric power, with the arc operating at low voltage (25 to 35 V) and high current (300 A to 400 A). Proportionately bigger values of arc voltage and current hold for bigger power units. The high value of the current brings to incandescence the tip of the carbon anode, with consequential disintegration of the carbon crystal, and release of highly ionized carbon atoms to the liquid. Jointly, the arc separates the water into mostly ionized atoms of hydrogen and oxygen. This creates in the immediate cylindrical surroundings of the arc a high temperature plasma, generally of about 7,000° F., which is composed by mostly ionized H, O, C, and other atoms.

A number of chemical reactions then occur within or near the plasma, such as: formation of H₂ and O₂ molecules; burning of H and O into H₂O; burning of C and O into CO; burning of CO and O into CO₂, and other reactions. Since all these reactions are highly exothermic, they cause the typical very intense glow of the arc within water as well as a rapid temperature increase of the water itself. The resulting gases cool down in the water surrounding the arc, and bubble to the surface, where they are collected.

The reasons for the lack of industrial applications of plasma-arc gas generators are numerous. The carbon rods generally have a very short duration. According to extensive, supervised, and certified measurements for power units of about 14 KW, the electrodes are typically composed of solid carbon rods of about ⅜ inch in diameter and about 1 foot length, and consume at the rate of about 1.250 inch in length per minute, thus requiring the halting of the operation, and replacement of the electrodes every 10 minutes. For 100 KW power input, the electrodes are generally comprised of solid carbon rods of about 1 inch diameter and of the approximate length of one foot, and are consumed under a continuous underwater arc at the rate of about 3 inches in length per minute, thus requiring servicing after 3 to 4 minutes of operation. In either case, current equipment requires servicing after only a few minutes of usage, which is unacceptable on industrial and consumer grounds for evident reasons, including increased risks of accidents for very frequent manual operations in a high current equipment.

The known processes of arc welding underwater are extremely inefficient. An underwater arc created by a 13 KW power unit produces 24.5 ft³ of gas per hour with the arc operating in DC mode at 34 V and 230 A. These settings yield the excessively low Efficiency: E=24.5 ft³/h/13 KWh=1.86 ft³/KWh.

The conventional arc processes produce a gas with an excessively high carbon dioxide content. Various measurements have established that the gas produced by an underwater arc generally contains 9% to 10% of carbon dioxide Thus, it is desired to improve the efficiency of the arcing process to more safely produce gas as well as to produce improved gases which are lower in undesirable components such as carbon dioxide.

### SUMMARY OF THE INVENTION

The invention relates to a method of obtaining a supply of a synthetic combustible gas having enhanced combustion properties that includes providing a fluid containing a carbonaceous material, creating an electric arc between spaced electrodes under the fluid to generate a combustible gas, and collecting the gas. The electrodes may be a consumable material, such as the anode may be advanced as it is consumed to maintain the desired spacing between the electrodes. The anode may be replenished as it is consumed to maintain the arc at essentially continuously operated constant voltage.

The carbonaceous material that may be used with the invention includes coal, sewage, hydrocarbons, or glycols, and optionally a surfactant may also be used, and the carbon may be present in elemental or organic form. Increasing the pressure of the carbonaceous fluid may increase the efficiency of the system. In one embodiment, the carbonaceous fluid may be directed or pumped through the arc to reduce the arc temperature and prolong the electrode life, as well as to optimize conversion of the carbonaceous material to the gas.

The invention also relates to an apparatus for obtaining a supply of a combustible gas having enhanced combustion properties. The apparatus includes a fluid containing a carbonaceous material within a vessel, spaced electrodes positioned in the fluid in the vessel, means for creating an electric arc between the electrodes, and means for collecting the gas generated by the flow of the fluid through the arc. Additionally, the apparatus may include means for moving the electrodes closer, e.g., moving the anode toward the cathode such that the arc can be continuously operated at an essentially constant voltage as the anode is consumed. Means for replenishing the anode as it is consumed and means for directing the fluid through the arc may also be used. The means for directing the gas may include a pump and the means for collecting the gas may include a vent in an upper portion of the vessel.

The invention also relates to an apparatus for obtaining a supply of a combustible gas having enhanced combustion properties that includes means for creating an electric arc between spaced electrodes under a fluid, wherein at least one electrode is an anode of consumable carbon material. The apparatus also includes means for moving the anode to maintain the spacing between the electrodes so that the arc can be essentially continuously operated at an essentially constant voltage, and means for collecting the gas.

### BRIEF DESCRIPTION OF THE DRAWINGS

The invention will be better understood in relation to the attached drawings illustrating preferred embodiments, wherein:

FIG. 1 shows one embodiment of the apparatus for producing a combustible gas according to the invention;

FIG. 2 shows an alternate embodiment of the apparatus of the invention having a hollow tungsten cathode;

FIG. 3 shows an embodiment of the invention having a hollow anode that rotates headwise against the edge of a hollow anode;

FIG. 4 shows an embodiment of the invention for the treatment of waste; and

FIG. 5 shows an elevational view of a section of the invention.

### DETAILED DESCRIPTION OF THE PREFERRED EMBODIMENTS

The fluid used in the process of the present invention includes water that contains carbon-rich and other molecules. In the process of the invention, an electric arc is created between spaced electrodes under the fluid to generate a combustible gas, which is collected for further use. The fluid can be directed through the arc between the spaced electrodes, thereby increasing the efficiency of converting the fluid to the combustible gas. Preferably, a carbonaceous liquid is used as the fluid. In one embodiment, inclusion of high concentrations of carbon in water can be present in such a percentage to eliminate altogether the need for carbon rods as the source of carbon for the creation of the combustible gas. The carbon can be present in water, e.g., in solution or suspension. Numerous different gas compositions are possible depending on the composition of the starting liquid, the electrodes and other operational factors.

In one embodiment, the process of the invention can eliminate the carbon rods used as electrodes, and possibly even the use of high temperature resistant materials that do not necessarily release carbon under an electric arc. Of course, two carbon rods can be used as the electrodes. Under a DC arc powered by 15 KW cathodes composed by a tungsten rod of about ¾ inches in diameter and 2 inches in length experience minimal consumption, with replacement needed over at least one month of operation. By comparison, under the same DC arc powered by 15 KW, anodes are exposed to much greater electromechanical solicitations and temperatures, thus experiencing a greater wear as compared to the anodes. An anode made up of conducting ceramics of about ¾ inch in diameter and about 1 foot in length lasts for at least 4 hours of continuous operations, thus requiring two services per day. Numerous additional materials are possible for the electrodes, each in a variety of different configurations.

The process of the present invention permits removal of the plasma from the arc via the flow of the fluid through the arc itself via a pump that continuously circulates the fluid in the reactor vessel with sufficient speed, the flow displaces the plasma immediately following its formation. Without being bound by theory, it is believed that this new process implies that the arc continuously generates new plasma, rather than being stationary within the same plasma and augmenting it.

The flow of the carbon-containing liquid through the arc helps cool the electrodes, thus permitting a large increase of their life. Since the plasma created by the arc can reach about 7,000° F., the cooling remains effective even when the fluid has reached its boiling temperature. Various configurations of fluid flow through the arc are possible as outlined below. They can be classified depending on the objective at hand, such as: 1) In the event high efficiency in the production of gas is desired, then the geometry of the configuration should be such to maximize the flow of the fluid through the arc while minimizing turbulence; 2) In the event one wishes to use the technology to sterilize biologically contaminated liquids, such as town sewage, while producing the gas, then the liquid should be forced through the arc; 3) In the event the maximization of the heat produced in the fluid is desired, then still different geometries are desirable.

The present invention produces a two-fold increase in efficiency over the prior art. First, there is a large increase of the efficiency in the production of a combustible gas for the same electric energy. Higher arc voltages permit longer arc gaps which can increase gas production, as established by several tests. Second, the fluid used for the production of the combustible gas, when flowing through the electric arc, is believed to be subjected to a number of reactions at the particle, nuclear, and molecular level which increase dramatically its temperature. Removal of the plasma from the arc is believed to dramatically reduce the recombination of H and O atoms into water, thus increasing the volume of gas produced and decreasing the dissipation of electric energy into heat with consequential increase of the efficiency.

The invention includes an automatic mechanism originating, controlling, and optimizing the arc, which is essentially based on: 1) The indicated addition to the fluid of carbon or other substances increasing the conductivity of the fluid and the length of the arc gap; 2) The automatic control of the arc gap via electromechanical means capable of maintaining the voltage essentially constant; and 3) means to optimize the voltage, thus permitting the maximization of the gap and the consequential maximization of the gas produced per each KWh of power used to generate the arc.

The flow of liquid through the arc permits a dramatic improvement of rapidity in the recycling of non-radioactive liquid waste. The electric arc is an excellent means for recycling liquid waste, because the arc decomposes waste into a plasma of mostly ionized atoms at very high temperature. Various processes then occur at the particle, nuclear, and atomic levels that cause the plasma to divide itself into volatile components constituting the gas of the invention, plus certain heavy components that may precipitate to the bottom of the equipment, where they can be collected and removed.

Existing equipment for sterilizing liquid wastes via an electric arc have an extremely low efficiency because the recycling area, that surrounding the arc, is small as compared to the rest of the liquid. This requires long periods of time until the entire liquid waste is eventually exposed directly to the arc, with erratic results and very low efficiency. On the contrary, the forced flowing of the liquid waste through the electric arc via a pump or other means, rapidly exposes the entire liquid to the arc, thus permitting a dramatic improvement in the recycling itself, as well as the increased efficiency in the production of gas.

The arc served by a 50 KW power unit can recycle liquid sewage as originating from households and municipalities at the rate of 25 gallons per minute when pumped through the arc. This corresponds to the recycling of 1,500 gallons of liquid sewage per hour, and 12,000 gallons per day with 8 working hours. During this process there is believed to be the complete elimination of all bacteriological activities from the very high electric current, the very intense light, and the very high temperature of the arc region.

Other liquid wastes can be used with the present invention, such as: paint sludge; bilge water; refinery pit oils; oil spills; processing oils; anti-freeze used in automotive radiators; oils used in engines; solvent contaminated waters; and other liquid waste. Even though generally not soluble in water, all of the above liquid wastes can be recycled with the new process of this invention by methods available to those of ordinary skill in the art.

The preferred embodiments hereinafter described relate to mobile equipment for the production of gas, such as with a power unit of about 50 KW DC, such as that by Miller Corporation of Appleton, Wis., commercially sold under the name of Summit Arc 1,000, requiring 53 KW of AC real power at 450 V, 3-phase, 60 Hertz, that delivers an arc for 100 percent duty cycle with 44 V DC and 1,000 A.

The preferred equipment is mobile in the sense that it is entirely contained in a trailer or other platform, optionally equipped with wheels for its easy transportation to the desired location. Due to the ease of its production, gas can be produced anywhere desired, thus eliminating the costly storage and transportation needed for the delivery of conventional fuels.

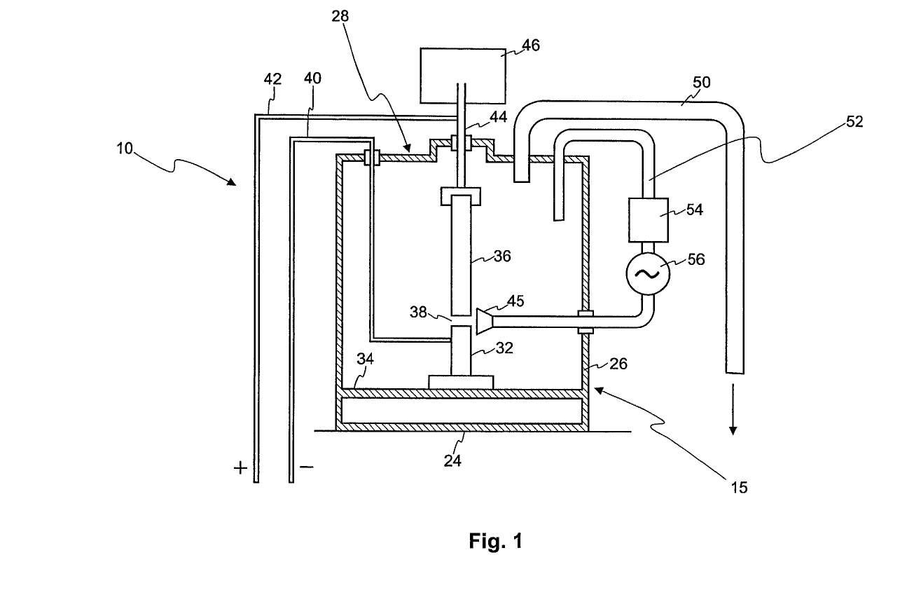

The apparatus, methods, and gas compositions of the invention can be prepared using various embodiments. A few of these typical embodiments are described below in reference to several apparatus embodiments illustrated in the drawings. Referring now to the drawings, FIG. 1 provides a sectional view of a gas production unit itself which comprises: an all enclosing reactor vessel fabricated by metal of approximately ¼ inch thickness and approximately 3½ feet wide, 4 feet long, and 2 feet high; the liquid more particularly described herein, which mostly fills up the vessel except for an empty layer at the top generally of the order of ¼ inch; the simplest possible realization of the arc, i.e., a stationary cathode composed by a tungsten rod of ¾ inch diameter and 3 inch length which is vertically oriented and placed at the bottom of the metal vessel, and electrically insulated to the same; an anode of ¾ inch thickness and 1 foot length comprising thoriated tungsten, glassy carbon, conducting ceramics, or other high temperature conductors, placed vertically oriented head-wide against said cathode; the automatic arc mechanism that initiates the arc by moving downward the anode to contact with the cathode, and subsequently retracts to the arc gap of about 1/32 inch, maintenance of the arc by keeping approximately constant its voltage via electromechanical means, and by optimizing the voltage via its variation as per gauge in the control panel; the flow of the liquid through the arc very simply realized by a tube of approximately 1/2 inch thickness terminating in a beak (nozzle) at least 1/4 inch wide and 1/4 inch thick, which tube is placed perpendicular to the cylindrical symmetry of the electrodes at the arc level in such a way that its 1/2 inch by 1/4 inch terminal beak is also placed vertically to the arc, but also at least 1/4 inch from the tips of the electrodes; and an outside pump circulating the liquid through the arc; along with sensors for other controls, and other operational items.

As shown in FIG. 1, the system 10 is for the production of a combustible gas from an electric arc submerged in a liquid. The system comprises a gas production vessel 15. The gas production vessel 15 has a base 24, an upstanding side wall 26 and an upper cover plate 28. A non-consumable cathode 32 is supported in the gas production vessel 15 by the lower surface, optionally with an insulating base 34 between the lower supporting surface 24 and the cathode32. A consumable anode 36 is also located within the gas production unit and supported from above. The relationship is to create a space 38 between the cathode and the anode for generating the arc and for flowing the fluid.

Electrical lines 40, 42 couple the source of potential and the cathode 32 and the anode 36, respectively. In this embodiment, an anode supporting shaft 44 of an electrically conducting material extends through the cover plate to permit a constantly replenishing supply of material for the anode. A holder 44 for the anode is supported there beneath. A drive member 46 is also provided to move the anode toward the cathode during operation and use. Automatic controls (not shown) can be included for monitoring and controlling the system during operation and use, such as on the drive member 46 equipment.

A first line 50 couples the cover plate with the pressure tank. This is for the passage of gas produced in the production unit into a pressure tank or other vessel for storage of the gas. A second fluid line 52 couples the cover of the gas production unit and the space between the cathode 32 and the anode 36. Such second line includes a pump 56 to circulate liquid through the vessel 15. The pumped fluid cools the arc during operation and use. The fluid is directed into the space 38 by using a beak or nozzle 45.

The cathode 32 is preferably fabricated of tungsten, a non-consumable electrode. The anode 36 is preferably fabricated of a consumable material such as thoriated tungsten, glassy, or carbon conductive ceramic material.

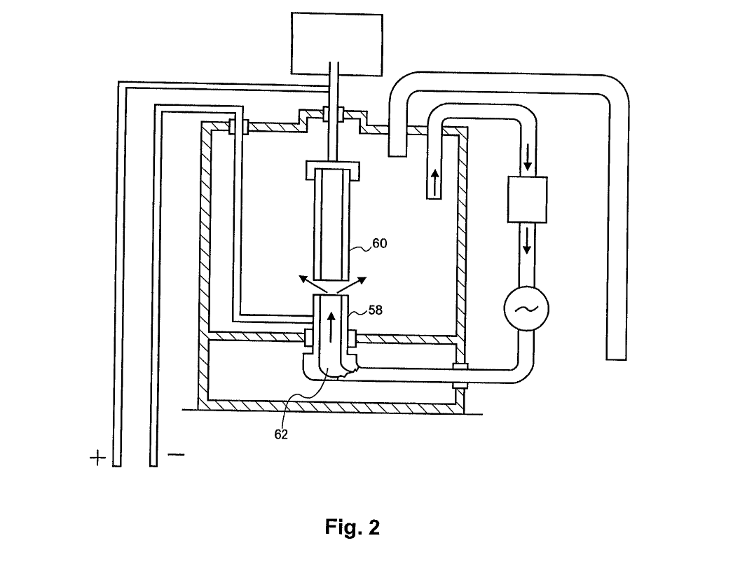

FIG. 2 describes essentially the same automatic arc system as that of FIG. 1, although with flow of the liquid via an cathode comprised 58 of a hollow type of tungsten of about 1 inch OD and 1½ inch ID through which the liquid is forced to flow toward the arc, with the anode 60 preferably being a tube of the same OD and ID as that of the cathode 58 to avoid uneven wear, although the anode 60 does not have to have internal flow of the liquid.

The anode 58 and the anode 60 are both preferably formed of a hollow tubular configuration. They preferably have a common interior diameter and a common exterior diameter. They are preferably spaced from each other along a common axis. In this manner, the output from the pump feeds the fluid up through the center 62 of the cathode 58 and outwardly therefrom into the space between the cathode 58 and the anode 60 for cooling purposes.

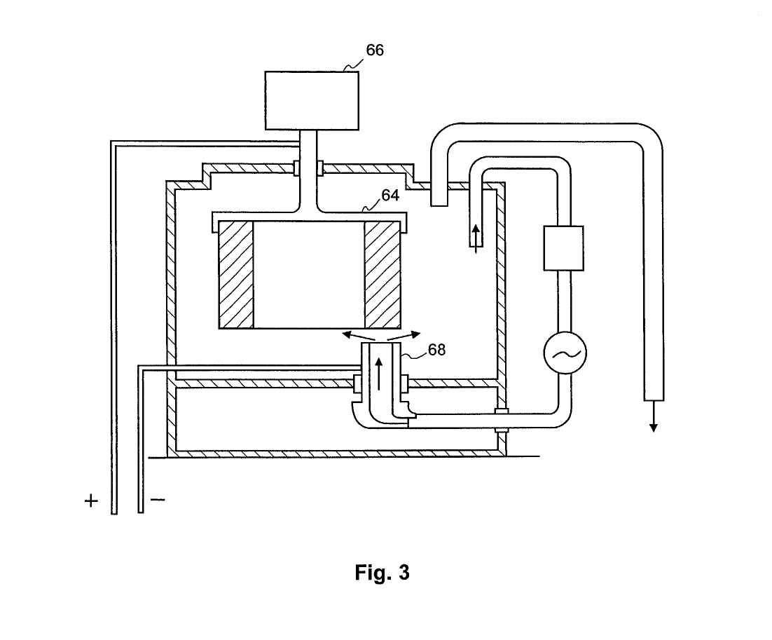

FIG. 3 depicts an arc system possessing longer life as compared to those of FIGS. 1-2. The system comprises the same long life hollow tungsten anode 68 as that of FIG. 2 with internal flow of the liquid toward the arc served by an outside pump, plus an anode 64 comprised of thoriated tungsten, glassy carbon, or conducting ceramics in the shape of a cylinder of approximately 1 inch thickness, 6 inch radius, and 1 foot in length, which is caused to rotate vertically head-wise against the edge of the anode 68, as well as to advance and retract as requested by the initiation of the arc, its maintenance and optimization. Depending on the selected material, the size and the cooling flow, the anode 64 of the above cylindrical configuration can have the same life long of the anode 68.

In FIG. 3, the anode 64 is formed as a large hollow tube having a common wall diameter. A motor 66 functions to rotate the anode during operation and use. The anode 68 is formed as a small hollow tube receiving the output from the pump for movement of the fluid therethrough to the space between the anode and anode for cooling. The exterior diameter of the anode is preferably essentially equal to the wall thickness of the anode.

As described above, the liquid of this invention comprises a base liquid preferably rich in H and O, optionally plus the addition of specially selected substances to increase the energy content of the gas produced, and to increase the volume of the gas via the addition of suitably selected acids or other substances that can increase the conductivity of the original liquid.

A representative case of base liquid is given by any form of water readily available on earth, such as: tap water, sea water, lake water, well water, etc., or any non-radioactive liquid waste to be recycled. Representative examples of additives are given by: coal in powder form resulting in a new form of gasification; hydrocarbons in liquid forms; and other substances that are not generally solvable in water; other substances that are solvable in water and have a high carbon content, such as ethylene glycol, anti-freeze, sugar, and their derivatives. A number of surfactants can also be added to achieve a better mixture of the solution and additives, such as up to 30 percent of C₁₂H₁₀O₂ with up to 10 percent of NaOH. Finally, preferred additives to increase the conductivity of the liquid include organic acids, and most preferably those that include only H, O, and C, such as acetic acid.

Representative total volumes of liquids in the above recyclers are 20 gallons that can produce approximately 5000 cubic feet of gas at ordinary pressure and temperature, plus a large amount of heat in the liquid as a result of reactions therein that can be utilized via conventional heat exchangers. Needless to say, the preferred embodiment contains means for periodically refilling of the liquid to the originally selected volume and composition. Additional fluid can, of course, be input via any conventional means (not shown).

An additional embodiment is that in which electrodes of approximately ¾ inch in diameter penetrate within a heat resistant tube, called venturi, of approximately 1 inch internal diameter, 3 inch outside diameter, and 3 feet in length, in such a way that the electric arc occurs in the approximate center of the internal diameter. The liquid to be recycled is then forced to pass through such a venturi with essentially the same pump system as described above. Forcing the liquid through the venturi can improve efficiency in the recycling of the liquid waste as compared to the flow of the same liquid in an open fashion around the electrodes, as well as the production of a gas of better quality.

In yet another embodiment, the system with a venturi may be used for recycling dilute contaminated liquids. In this case, the complete recycler comprises: Station 1, comprising a macerator pump; Station 2, comprising means to measure the flow of the sewage, such as a flowmeter; Station 3, comprising one or more recyclers with venturi each powered by a 50 KWh DC power source with ¾ inch electrodes, each having an independent or a common automatic feeder, the recyclers being connected in series with individual bypasses for individual servicing without disconnecting the recycling; Station 4, comprising gas collection stations, one per each electric arc; optionally Station 5, comprising a degaussing equipment for the removal of the magnetic polarization of the liquid; optionally Station 6, comprising a centrifuge for the removal of solid in the recycled liquid; optionally Station 7, comprising a final filtering station.

In still another embodiment, the vessel described above can be equipped with means for the extrusion of the anode at the speed of its consumption to keep constant the electric arc voltage. The extrusion means can be essentially comprised of the selected base elements, such as graphite, coal, or other, a bonding element, such as tar, epoxy, or other, and bonding means, such as temperature, which are combined together into a screw powered by an electric motor at a speed controlled by the automatic controller of the arc which extrudes the composed anode in the outside diameter of ¾ inches in the desired length, and at the desired speed. An advantage of the latter means being the continuous capability of working without any interruptions. Another advantage is the complete automation of the new coal gasification process described in the preceding embodiment.

The means for the creation of the liquid from the above identified substances are rather diversified because they depend on the substance selected and their scope. When creating liquid prior to the initiation of the production of gas, the arc voltage cannot be controlled via the gap because each arc within each liquid requires its own characteristic voltage per each KW and related gap. The volume of combustible gas produced per KWh increases with the increase of the KW. The characteristic arc voltage per each given power source varies with the variation of the absorbed KW, the chemical composition of the adopted liquid, the nature of the electrodes, and other factors.

In view and consideration of the above features, it is evident that the most efficient automation of the arc feeding mechanism is that based on the optimization of the voltage of the arc per each given value of the KW and per each given chemical composition of the liquid.

The preferred remotely controlled automation of arc mechanism is therefore that which identifies the gap corresponding to the biggest possible voltage, and the highest possible voltage can be adjusted for different KW and different liquids.

A typical remotely controlled production of gas as shown in FIG. 3 is the following:

1) Electric power is switched on in the main panel with amperage automatically set at a minimum of about 100 A, while the cylindrical anode 64 automatically initiates its rotation on the edge of the stationary cathode 68;

2) The automatic control mechanism advances the cylindrical anode 64 to the point of initiation of an arc, as identified by the absorption of amperes;

3) The automatic control mechanism then retracts said cylindrical anode 64 to the characteristic arc gap, while the amperes are released to reach a pre-set limit, for example 900 amperes, thus establishing a regular arc;

4) The arc gap is controlled by the characteristic DC voltage of 44 V DC;

5) Whenever the arc voltage increases, the automation moves forward the cylindrical anode 64 to restore said characteristic gap value and related voltage;

6) The operator has the capability of optimizing the characteristic arc voltage by setting its value to the maximal volume production of the gas, as measured by the flowmeter in the control panel;

7) The operation of the equipment then continues automatically until the entire consumption of the anode tube 64, at which time the remaining part of the carbon cylindrical anode is retracted, for example, about ½ inch, and the equipment is switched off automatically.

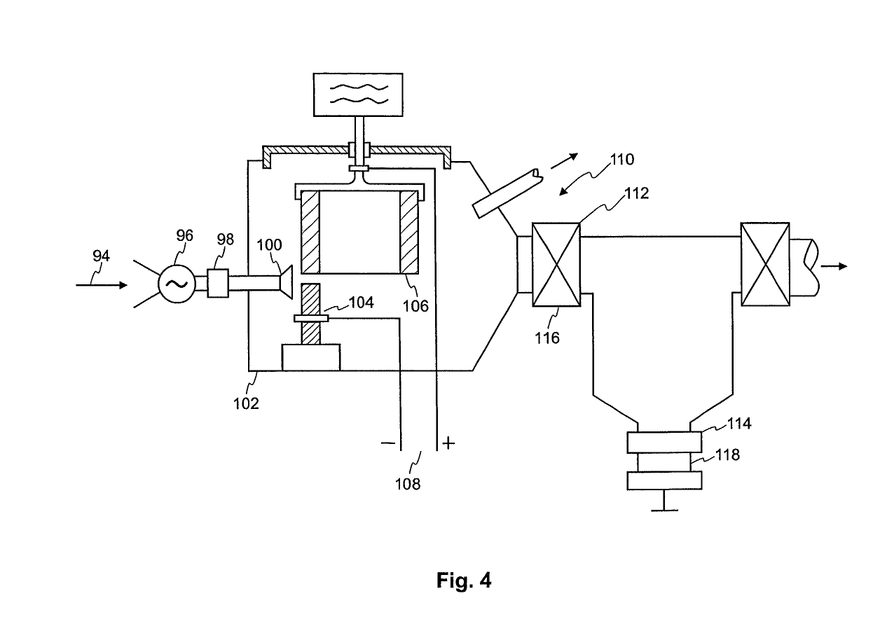

FIG. 4 depicts a preferred embodiment for the equipment of this invention used for the recycling of liquid sewage from households or municipalities, which is comprised of any desired number of individual stations, each with the following main structure and functions:

I) A DC arc power unit such as the Miller Summit Arc 1,000 described above with 44 V DC and 1,000 A DC or any equivalent electric generator powered by a diesel engine;

II) A metal vessel in various sections and shapes as described below with about 1 inch general thickness to withstand high pressures in which said liquid sewage is made to flow, and comprising in the flow direction: a pump; on-off valve of said flow; a restriction of the vessel down to 1 inch ID and 3 inch length, e.g., a nozzle, to force the liquid sewage to flow through the arc; the electric arc station including electrodes placed directly in front of the vessel restriction, rapid means for their replacement, and automatic means for initiating, maintaining and optimizing the arc as in preceding embodiments; the outlet for the gas produced; optionally a station for the degaussing of the liquid coming out of the arc comprising at least six sources of microwaves with resonating water frequency radially disposed outside a restriction of said vessel of 2 inch in ID and 5 inches in length and emitting their resonating frequency toward the axial center; a chamber with dimension 5 ft. by 5 ft. by 5 ft. for the precipitation of solids to the bottom, with means for their removal at the bottom without halting the operation; a filtering station; and the final outflow of water usable for irrigation.

III) A long life arc mechanism specifically designed for recycling liquid sewage in which the cathode comprises a tungsten rod of 1 inch diameter and 5 inches length, and the anode is a cylinder of 1 inch thickness, 6 inches in radius and 1 foot in length comprising carbon in graphite form as conventionally used for welding, which is made to rotate head-wise on the edge of the tungsten cathode, the arc being controlled by the same automatic mechanism as that previously described, and the anode being made of carbon due to the general lack of sufficient carbon in the liquid sewage to be recycled; means for rapidly changing the electrodes; and various controls as per preceding embodiments.

Another embodiment of the final machine or system disclosed is shown in FIG. 4. Such system is for the treatment of liquid sewage. Such system comprises a liquid sewage inflow line 94 with a pump 96 in association therewith to effect the feeding therethrough of liquid fluid to be treated. The pump is followed by a shutoff valve 98 and an exit port 100.

A reaction vessel 102 receives the output of the exit port. Such vessel comprises an anode 104 and an anode 106 with a space there between. Also included is a source of electrical potential 108 to effect the flow of current across the space between the electrodes which acts to effect an arc. The exit port is located adjacent to the space between the cathode and the anode to effect the cooling thereof during operation and use. The anode shown is hollow and rotates, but it should be understood that other anode arrangements are possible, such as a fixed anode opposing the cathode and even of the same size.

A fluid output assembly is next provided. Such assembly optionally includes a degaussing station 110 for the liquid sewage passed through the arc and treated by the arc. A mechanical filtering station 112 and an irrigation water outflow portion next follows the optional degaussing station. Lastly, is an optional solid precipitation chamber 114 with a shut off valve 116 and removable solid container 118. Such container can be located between the optional degaussing station and the filtering station and can receive solid waste to be disposed of.

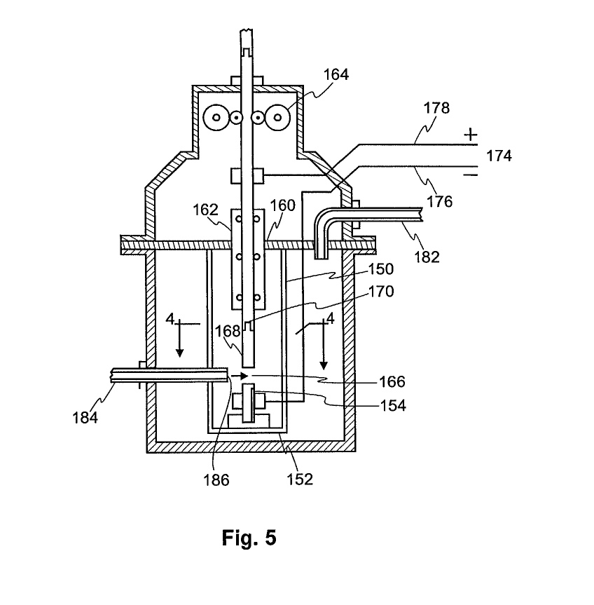

Referring to FIG. 5, an apertured intermediate support plate 142 is provided between the flanges of the side wall and cover plate. Bolts and associated nuts are provided for the releasable coupling of the support plate between the flanges. The support plate has downwardly extending legs. A horizontal shelf 152 supports a cylindrical tungsten anode 154. A carbon rod anode is supported in the vessel and extends through an aperture 160 in the cover plate and sealing bushing 162 in the support plate. Automatic feeding controls 164 are provided in this embodiment to advance sequential carbon rods toward the cathode to create a space 166 between the anode and the anode. A projection 168 is adapted to be fit within a recess 170 of the next adjacent carbon to effect the continuous feeding of carbon rods into the reaction vessel. A source of electrical potential 174 is next provided. The source of electrical potential has electrical leads 176, 178 separately coupling the source of potential with the cathode and with the anode to generate a gas-producing electrical arc between the cathode and anode.

A first fluid line 182 is provided. The first fluid line is coupled with respect to the vessel and functions to allow the passage of gas produced in the vessel. A second fluid line 184 is coupled with respect to the vessel. The second fluid line has an outlet orifice 186 adjacent and transverse to the space between the cathode and the anode. Although not shown, the orifice can include a device for directing the fluid flow into the space between the electrodes. A pump feeds liquid to the space between the cathode and the anode, such as for cooling purposes, during the application of electrical potential to the cathode and the anode for the creation of combustible gas.

The present invention also includes the gas, the use of certain liquids for generating the gas, and the method of generating the gas. More specifically, the combustible gas fabricated by the passage of a liquid containing water and carbon particles through a submerged electric arc, the gas including hydrogen, oxygen, and carbon dioxide comprising no more than about 12 percent of the gas. The liquid contains water and carbon particles of about 10 to 15 percent of the liquid and is adapted for use in generating a combustible gas including hydrogen, oxygen, and carbon dioxide comprising no more than 12 percent of the gas by the passage of the liquid through a submerged electric arc. Lastly, the new and improved hydrogen, oxygen, and no more than 12 percent carbon dioxide includes the steps of forming an electric arc submerged under a liquid, the liquid containing water and carbon particles, and flowing liquid through the arc for cooling purposes.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A method of obtaining a supply of a synthetic combustible gas having enhanced combustion properties, which method comprises:
providing a fluid containing a carbonaceous material therein;
creating an electric arc between spaced electrodes under the fluid to generate a combustible gas; and
collecting the gas to obtain the supply of the combustible gas.

2. The method of claim 1, which further comprises providing one of the electrodes as a consumable carbon material.

3. The method of claim 2, wherein the consumable carbon electrode is an anode and is advanced as the electrode is consumed in order to maintain a desired spacing between the electrodes.

4. The method of claim 3, which further comprises replenishing the consumable carbon anode as it is consumed so that the arc can be essentially continuously operated at a constant voltage.

5. The method of claim 1, wherein the carbonaceous material comprises at least one of coal, sewage, a hydrocarbon, or a glycol, and is optionally present in the fluid in combination with a surfactant.

6. The method of claim 5, which further comprises directing the fluid through the arc to optimize conversion of the carbonaceous material to the gas.

7. The method of claim 1, which further comprises subjecting the fluid to pressure which is sufficiently increased to provide an increased gas generation efficiency over operation at atmospheric pressure.

8. The method of claim 7, wherein the carbonaceous material comprises carbon material in elemental or organic form.

9. A method of obtaining a supply of a synthetic combustible gas having enhanced combustion properties, which method comprises:
creating an electric arc between spaced electrodes under a fluid and a carbonaceous material to generate a combustible gas;
directing the fluid to flow through the arc to optimize conversion of the carbonaceous material to increase the efficiency of generation of the combustible gas; and
collecting the gas to obtain the supply of combustible gas.

10. The method of claim 9, which further comprises providing one of the electrodes as a consumable carbon material.

11. The method of claim 10, wherein the consumable carbon electrode is an anode and is advanced as the electrode is consumed in order to maintain a desired spacing between the electrodes.

12. The method of claim 11, which further comprises replenishing the consumable carbon anode as it is consumed so that the arc can be essentially continuously operated at a constant voltage.

13. The method of claim 9, wherein the carbonaceous material comprises at least one of coal, sewage, a hydrocarbon, or a glycol, and is optionally present in the fluid in combination with a surfactant.

14. The method of claim 9, wherein the fluid is pumped through the arc at a rate sufficient to reduce arc temperature and prolong electrode life.

15. The method of claim 9, which further comprises subjecting the fluid to pressure which is sufficiently increased to provide an increased gas generation efficiency over operation at atmospheric pressure.

16. A method of obtaining a supply of a synthetic combustible gas having enhanced combustion properties, which method comprises:
creating an electric arc between spaced electrodes under a fluid, wherein at least one electrode is an anode of consumable carbon material;
moving the anode to maintain the spacing between the electrodes so that the arc can be essentially continuously operated at an essentially constant voltage; and
collecting the gas to obtain the supply of combustible gas.

17. The method of claim 16, which further comprises replenishing the consumable carbon anode as it is consumed so that the arc can be essentially continuously operated at a constant voltage.

18. The method of claim 16, wherein the fluid comprises a carbonaceous material.

19. The method of claim 18, wherein the carbonaceous material comprises coal, sewage, a hydrocarbon, or a glycol, and is optionally present in the fluid in combination with a surfactant.

20. The method of claim 18, which further comprises directing the fluid through the arc to optimize conversion of the carbonaceous material.

21. The method of claim 16, wherein the fluid is pumped through the arc at a rate sufficient to reduce arc temperature and prolong electrode life.

22. An apparatus for obtaining a supply of a combustible gas having enhanced combustion properties comprising:
a fluid containing a carbonaceous material therein;
a vessel for retaining the fluid therein;
spaced electrodes positioned in the in the vessel fluid;
means for creating an electric arc between the spaced electrodes to generate a combustible gas; and
means for collecting the gas for obtaining the supply of the gas.

23. The apparatus of claim 22, wherein the electrodes comprise a cathode and an anode, and wherein the anode comprises a carbon material.

24. The apparatus of claim 23, further comprising means for moving the carbon anode toward the cathode at a rate sufficient to maintain the distance therebetween so that the arc can be continuously operated at an essentially constant voltage.

25. The apparatus of claim 23, further comprising means for replenishing the carbon anode so that the arc can be operated continuously.

26. The apparatus of claim 22, further comprising means for directing the fluid through the arc to optimize conversion of the carbonaceous material to the gas.

27. The apparatus of claim 26, wherein the directing means comprises a pump and the carbonaceous material comprises coal, sewage, a hydrocarbon, or a glycol, optionally in combination with a surfactant.

28. The apparatus of claim 22, wherein the means for collecting the gas comprises a vent in an upper portion of the vessel.

29. An apparatus for obtaining a supply of a combustible gas having enhanced combustion properties comprising:
means for creating an electric arc between spaced electrodes under a fluid, wherein at least one electrode is an anode of consumable carbon material;
means for moving the anode to maintain the spacing between the electrodes so that the arc can be essentially continuously operated at an essentially constant voltage; and
means for collecting the gas to obtain the supply of combustible gas.
